(19) United States
(12) Patent Application Publication
(10) Pub. No.: US 2019/0013002 A1
(43) Pub. Date: Jan. 10, 2019

(54) STRUCTURAL LAMINATE SOUND BARRIER

(71) Applicant: WESTHILL INNOVATION INC., Simcoe (CA)

(72) Inventors: Gina SUCCI, Ancaster (CA); Arash JENAB, Hamilton (CA)

(21) Appl. No.: 16/027,969

(22) Filed: Jul. 5, 2018

Related U.S. Application Data
(60) Provisional application No. 62/529,072, filed on Jul. 6, 2017.

(51) Int. Cl. G10K 11/168; B32B 5/16; B32B 7/12; B32B 15/08; B32B 15/06; B32B 27/20

(52) U.S. Cl. CPC G10K 11/168; B32B 5/16; B32B 7/12; B32B 2307/102; B32B 15/06; B32B 27/20; B32B 15/08

(57) ABSTRACT

A sound barrier includes: a core member having a perimeter separating opposing first and second side surfaces, the core member formed from a core material including a fiber and a binder; a first reinforcing skin member having a first inner surface affixed to the first side surface of the core member, and a first outer surface facing away from the core member; a second reinforcing skin member having a second inner surface affixed to the second side surface of the core member, and a second outer surface facing away from the core member; and a sound attenuation sheet of crumb rubber applied to the first outer surface of the first reinforcing skin member.

### CROSS-REFERENCE TO RELATED APPLICATIONS

This application claims priority from U.S. Provisional Patent Application No. 62/529072, filed Jul. 6, 2017, the contents of which is incorporated herein by reference.

### FIELD

The specification relates generally to sound or noise barriers, and specifically to a structural laminate sound barrier.

### BACKGROUND

Sound barriers (also referred to as noise barriers) are employed, for example along highways, railways, industrial sites and the like, to protect residential or other noise-sensitive areas from noise pollution. Such barriers may include concrete structural members bearing sound-attenuating coatings. The weight of such materials may require heavy equipment to provide foundations and install the barriers.

### SUMMARY

An aspect of the specification provides a sound barrier, comprising: a core member having a perimeter separating opposing first and second side surfaces, the core member formed from a core material including a fiber and a binder; a first reinforcing skin member having a first inner surface affixed to the first side surface of the core member, and a first outer surface facing away from the core member; a second reinforcing skin member having a second inner surface affixed to the second side surface of the core member, and a second outer surface facing away from the core member; and a sound attenuation sheet of crumb rubber applied to the first outer surface of the first reinforcing skin member.

### BRIEF DESCRIPTIONS OF THE DRAWINGS

Embodiments are described with reference to the following figures, in which:

FIG. 1 depicts a sound barrier panel;

FIG. 2 depicts an exploded view of the sound barrier panel of FIG. 1;

FIG. 3 depicts the detail view F-3 of an outer surface of the sound barrier panel of FIG. 1;

FIG. 4 depicts the detail view F-4 of the sound barrier panel of FIG. 1;

FIG. 5 depicts the partial cross-section F-5 of the sound barrier panel of FIG. 4;

FIG. 6 depicts a sound barrier panel according to another embodiment; and

FIGS. 7-8 depict the assembly of a sound barrier employing a plurality of the panel of FIG. 6; and

FIG. 9 depicts the assembly of a sound barrier employing a plurality of the panels of FIG. 1.

### DETAILED DESCRIPTION

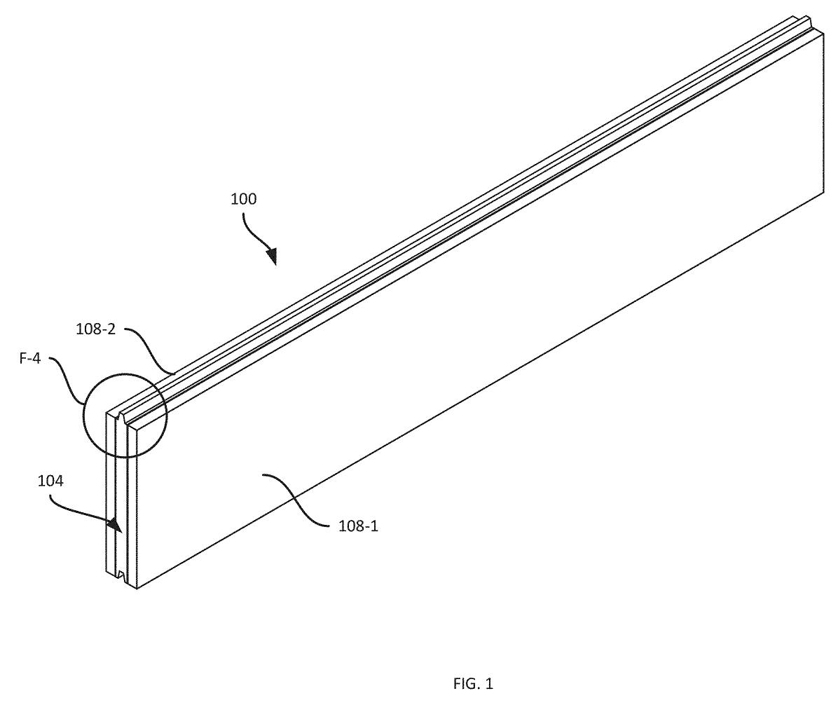

FIG. 1 depicts a sound barrier panel 100. As will be described in greater detail below, the panel 100 may be employed (e.g. in combination with other panels) to construct sound barrier walls, for instance lining highways, rail corridors, shooting ranges, and the like. In other examples, the panel 100 can be employed as a structural component of a building, trailer, shipping container, or the like. The panel 100 includes a core member 104 supporting at least one sound attenuating sheet 108. In the illustrated example, the core member 104 supports a first sound attenuating sheet 108-1 and a second sound attenuating sheet 108-2. In some examples, one of the sound attenuating sheets may be omitted (e.g. on a side of the panel 100 facing away from a source of noise, such as a side facing toward a residential area and away from a highway).

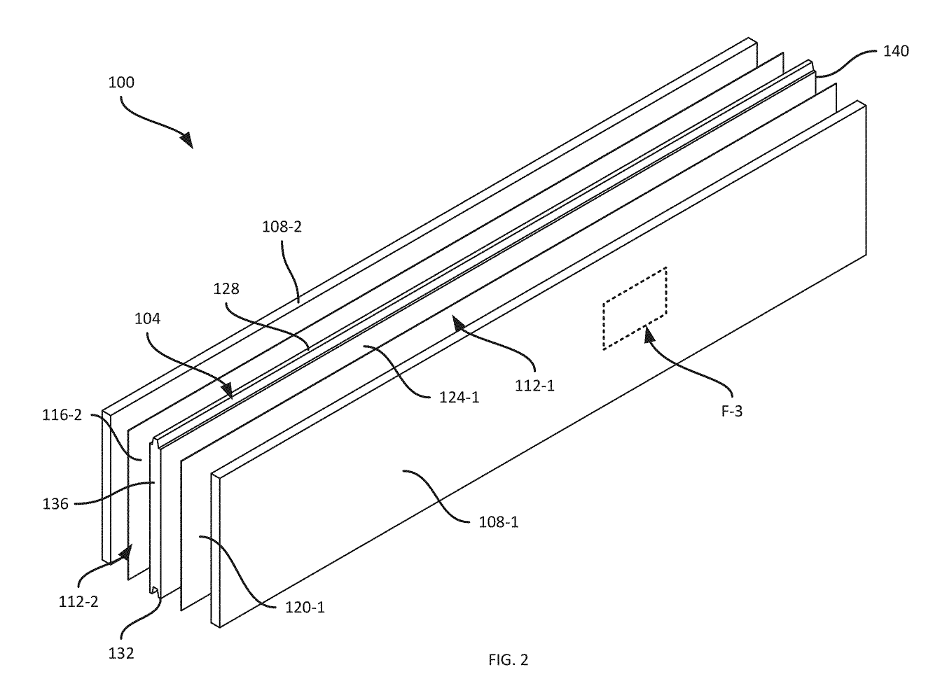

Turning to FIG. 2, an exploded view of the panel 100 is shown. As seen in FIG. 2, the panel 100 also includes a first reinforcing skin member 112-1 and a second reinforcing skin member 112-2. Each skin member 112 includes an inner surface 116 (the inner surface 116-2 of the skin member 112 is visible in FIG. 2), referred to as “inner” because it faces the core member 104. Each skin member 112 also includes an outer surface 120 (the outer surface 120-1 of the skin member 112 is visible in FIG. 2), referred to as “outer” because it faces away from the core member 104.

The skin members 112 are affixed to the core member 104 via a suitable adhesive (not shown in FIG. 2), which may be sprayed, rolled or the like, onto the core member 104 during manufacture of the panel 100. As shown in FIGS. 1 and 2, each skin members extends over substantially the entirety of a corresponding side surface of the core member 104. In other words, the inner surface of the skin 112-1 has substantially the same shape and size as a first side surface 124-1 of the core member 104. Likewise, the inner surface 116-2 of the second skin member 112-2 has substantially the same shape and size as a second outer surface of the core member 104 (facing away from the viewer in FIG. 2).

The panel 100, in the illustrated example, has a generally rectangular shape. The core member 104 thus includes a rectangular perimeter dividing the first side surface 124-1 from the second side surface. The perimeter, in the present example, includes an upper edge 128 and an opposing lower edge 132, which are substantially parallel to each other. The perimeter also includes substantially parallel opposing side edges 136 and 140. As seen in FIG. 2, the upper and lower edges 128 and 132 are substantially perpendicular to the side edges 136 and 140. Each of the other components of the panel 100 has substantially the same shape as the core member 104. In other examples, however, the panel 100 can take any of a variety of shapes, and therefore need not include a perimeter defined by pairs of parallel edges as shown in FIG. 2.

The core member 104 and the skin members 112 together provide structural functionality for the panel 100, both supporting the sound attenuation sheets 108 and supporting the panel 100 itself (e.g. in conjunction with other panels). More specifically, the skin members 112 may provide bending resistance to the core member 104 (e.g. resisting bending moments applied in planes perpendicular to the surfaces 124), while the core member 104 resists compressive loads (e.g. the weight of additional panels supported on the panel 100).

The core member 104 is fabricated from a composite material including at least a fiber and a binder. The fiber can include recycled materials (e.g. waste materials from other processes) such as rice husk, wood chips or fibers, carpet core and/or carcass, or the like. The fiber can also include, instead of or in addition to recycled materials, virgin materials (including any of the above-mentioned fibers). The fiber can include any suitable combination of natural and synthetic fibers; further examples of the fiber include nylon, polyethylene terephthalate (PET), polypropylene, and the like. The binder includes any of a variety of suitable binding agents, such as thermosetting polymers (e.g. polyurethane, polypropylene), thermoplastic polymers (e.g. polyvinyl chloride (PVC″)) and the like. The core member 104 can also include suitable additives, such as a foaming agent to reduce the density of the core member 104, stabilizing agents, coloring agents, fire retardants, and the like.

The skin members 112 are metallic in the present embodiment. In particular, each skin member 112 is a sheet of steel (e.g. stainless steel, although any of a wide variety of steels may be employed, including galvanized steel, painted steel and the like). In other embodiments, the skin members 112 can be sheets of aluminum or other suitable metals (e.g. titanium). In still other embodiments, the skin members 112 can be fabricated from other suitable reinforcing materials, such as a carbon fiber composite, Kevlar or the like. The skin members 112 can also include, in some embodiments, one or more coatings, e.g. to enhance binding of the above-mentioned adhesives, to inhibit corrosion, or the like. The skin members 112 are illustrated as planar members, but in other embodiments can also be corrugated.

Further examples of the composition of the core member 104 and the skin members 112 may be found in Canadian Patent No. 2564406, the contents of which is incorporated herein by reference.

The sound attenuation sheets 108 each include a sheet of crumb rubber applied to the outer surfaces 120 of the skin members 112, for example via the application of one or more suitable adhesives. For example, crumb rubber may be rolled onto the skin members 112 following attachment of the skin members 112 to the core member 104. In a further example, a bed of crumb rubber (and other suitable components, as discussed below) may be prepared and the skin member 112 may be placed onto the bed to affix the bed to the skin member 112. The adhesive(s) employed to bind the sound attenuation sheets 108 to the skin members 112 may the same as the adhesive(s) employed to bind the skin members 112 to the core member 104. In other examples, different adhesives may be employed between the core member 104 and the skin members 112 than between the skin members 112 and the sound attenuation sheets 108.

The crumb rubber of the sound attenuation sheets 108 provides acoustical insulation. That is, the crumb rubber dissipates, absorbs and/or otherwise attenuates acoustic energy impacting one side of the panel 100 such that a reduced portion of the acoustic energy is transmitted to the other side of the panel 100. The crumb rubber includes granules of any of a variety of rubbers, including recycled rubbers (e.g. from recycled tires, and the like). The sound attenuation sheets 108 can also include other granular material, such as polymers (e.g. recycled or virgin plastic). The granules are bound by any suitable binding agent, or combination of binding agents, including polyurethane, latex, and the like,

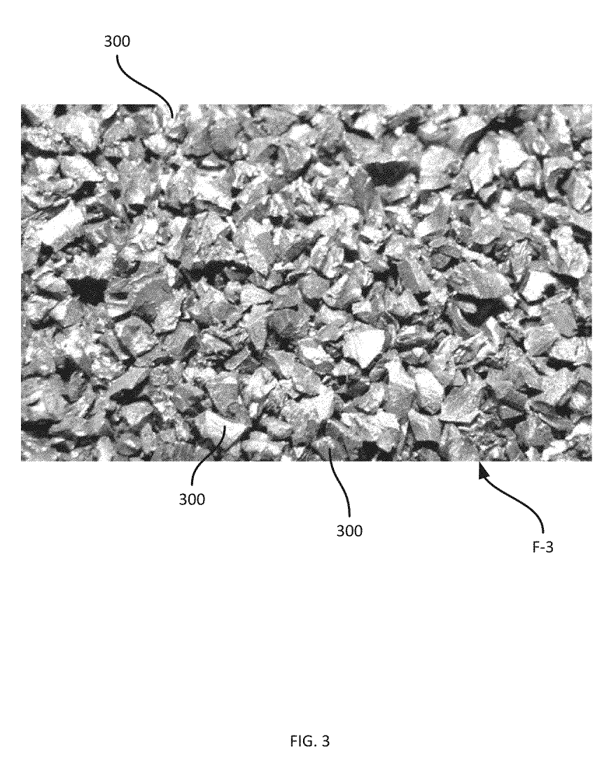

The granules of the crumb rubber (as well as any other granules included in the sound attenuation sheets 108) can have a variety of sizes. Preferably, the granules are between about 2 mm and about 25 mm in size. The sound attenuation sheets 108 therefore, as a result of the sizes of the granules, typically have rough surfaces, which may further absorb and/or dissipate inbound acoustic energy. A portion of an outer surface of the sound attenuation sheet 108-1 indicated as F-3 in FIG. 2, is shown in detail in FIG. 3. As shown in FIG. 3, although the sound attenuation sheets 108 are shown in FIGS. 1 and 2 as having smooth surfaces for simplicity of illustration, the outer surfaces of the sound attenuation sheets 108 may in fact be textured as a result of the granules 300 of crumb rubber,

The sound attenuation sheets 108 can also include one or more additives, such as coloring agents (e.g. mulch coloring solution or other pigments, whitening agents such as aluminum oxide (Al₂O₃) or titanium oxide (TiO₂)), color stabilizing agents, anti-graffiti agents or coatings (e.g. titanium oxide (TiO₂)), ultraviolet protection agents, fire retardants, and the like.

The panel 100 can have various configurations and sizes, based on the application for which the panel 100 is intended. An example panel 100 for use in constructing a sound barrier along a highway, for example, can include a core member 104 with a thickness (i.e. the dimension between the first side surface 124-1 and the second side surface) of about 25 mm (about 1 inch). The skin members 112 can each have a thickness of about 0.5 mm to about 2.25 mm (about 0.02 inches to about 0.09 inches), and the sound attenuation sheets can each have a thickness of about 20 mm to about 40 mm (about ¾ inches to about 1.5 inches). The panel 100 may have a length of about 1.5 m to about 7.5 m (about 5 feet to about 25 feet) and a height of about 0.3 m to about 1.2 m (about 12 inches to about 48 inches).

As will be apparent, a wide variety of other dimensions may be selected for any of the components of the panel 100. For example, in another embodiment, the core member 104 has a thickness of about 50 mm (about 2 inches), the skin members 112 each have a thickness of about 0.5 mm (0.02 inches), and the sound attenuation sheets can each have a thickness of about 25 mm (about 1 inch). In further embodiments, when two sound attenuation sheets 108 are employed, the sound attenuation sheets 108 need not have the same thickness.

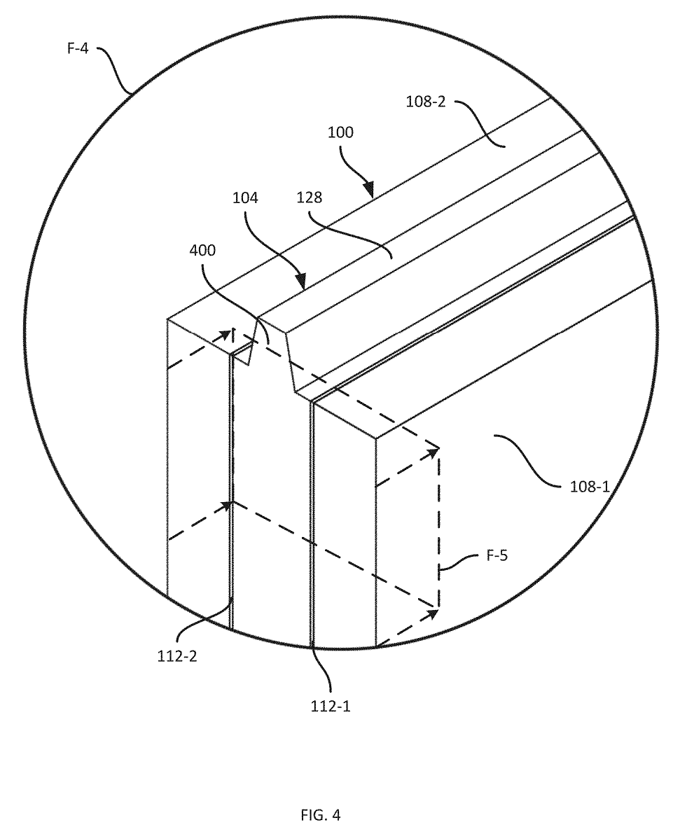

Turning to FIG. 4, certain additional structural features of the panel 100 are illustrated. In particular, FIG. 4 illustrates a portion (indicated at F-4 in FIG. 1) of the panel 100 in detail. As shown in FIG. 4, the core member 104 includes a tongue 400 at the upper edge 128. The panel 100 also includes a complementary groove at the lower edge 132. Thus, the panel 100 is configured to receive another panel such that the groove of the other panel engages with the tongue 400. Similarly, the panel 100 can be placed on top of another panel, such that the groove of the panel 100 (visible in FIGS. 1 and 2) engages with the tongue of the other panel.

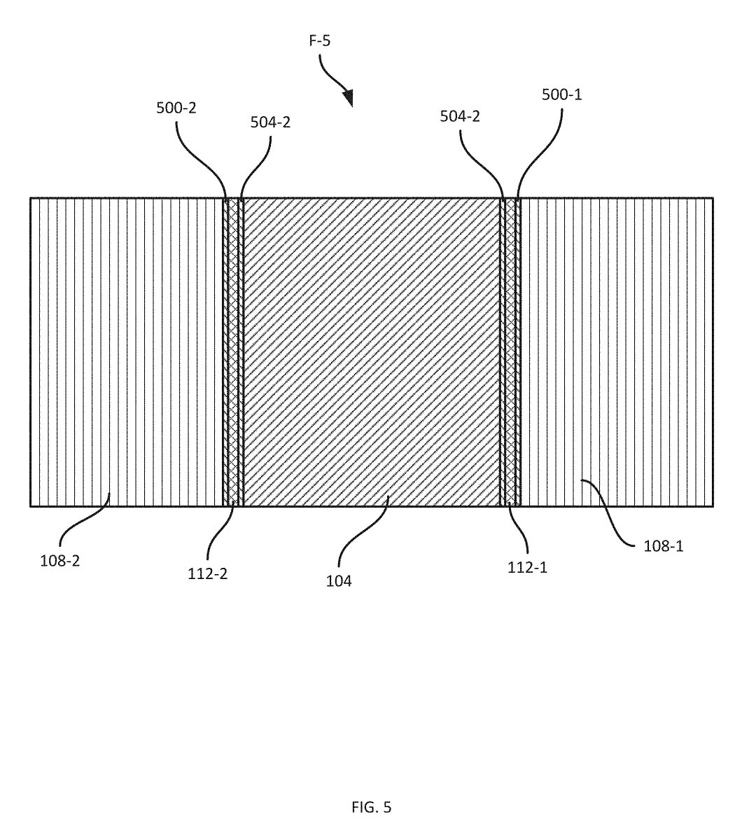

Also indicated in FIG. 4 is a partial cross-section F-5, illustrated in further detail in FIG. 5. In particular, FIG. 5 illustrates the sound attenuation sheets 108, the skin members 112 and the core member 104. FIG. 5 also illustrates a plurality of adhesive layers (not visible in FIGS. 1-4) affixing the components of the panel 100. Specifically, as shown in FIG. 5, a first pair of adhesive layers 500-1 and 500-2 affixes the attenuation sheets 108 to the skin members 112, and a second pair of adhesive layers 504-1 and 504-2 affixes the skin members 112 to the core member 104.

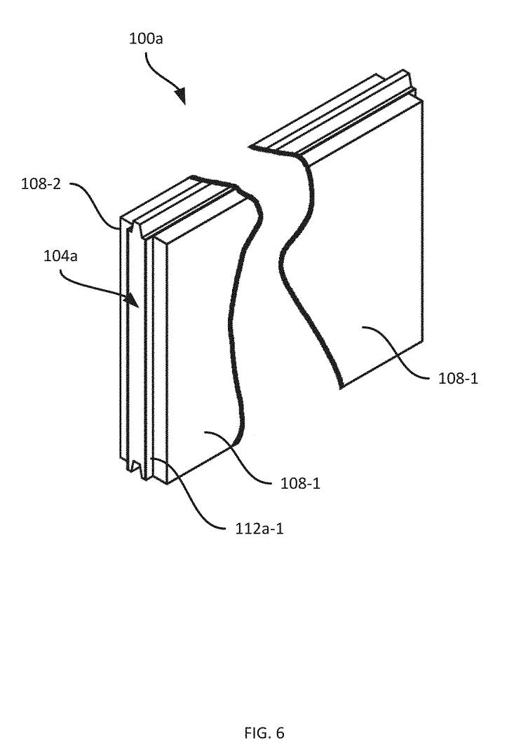

Referring to FIG. 6, another embodiment of the panel 100 is illustrated as a panel 100a. The panel 100a includes the sound attenuating sheets 108-1 and 108-2. The panel 100a, however, includes a lengthened core member 104a and skin members 112a. The core member 104a and the skin members 112a have a greater length than the sound attenuation sheets 108, such that a portion of the core member 104a and skin members 112a extends beyond the sound attenuation sheets at each end of the panel 100a.

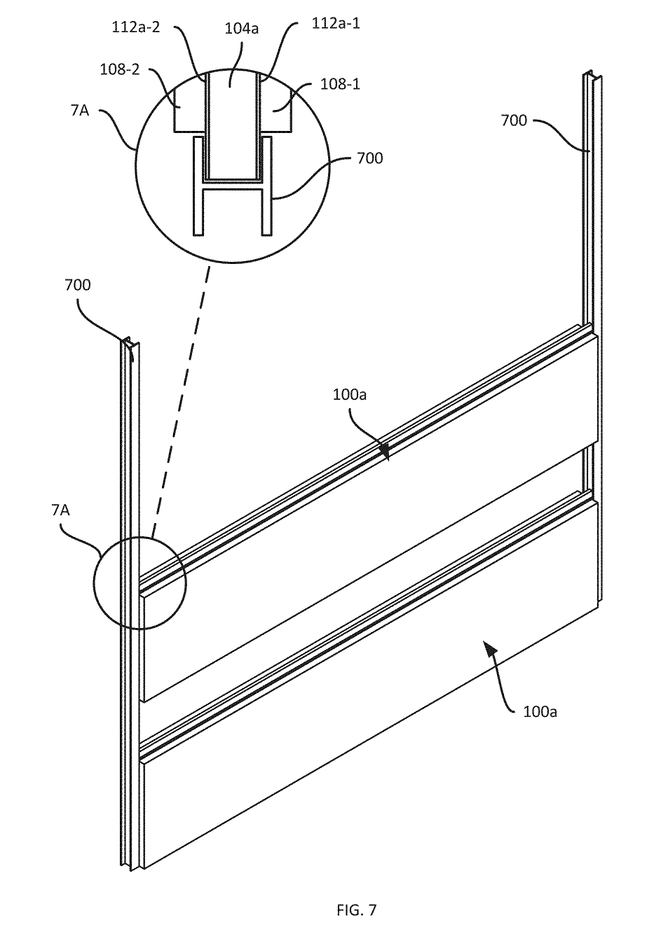

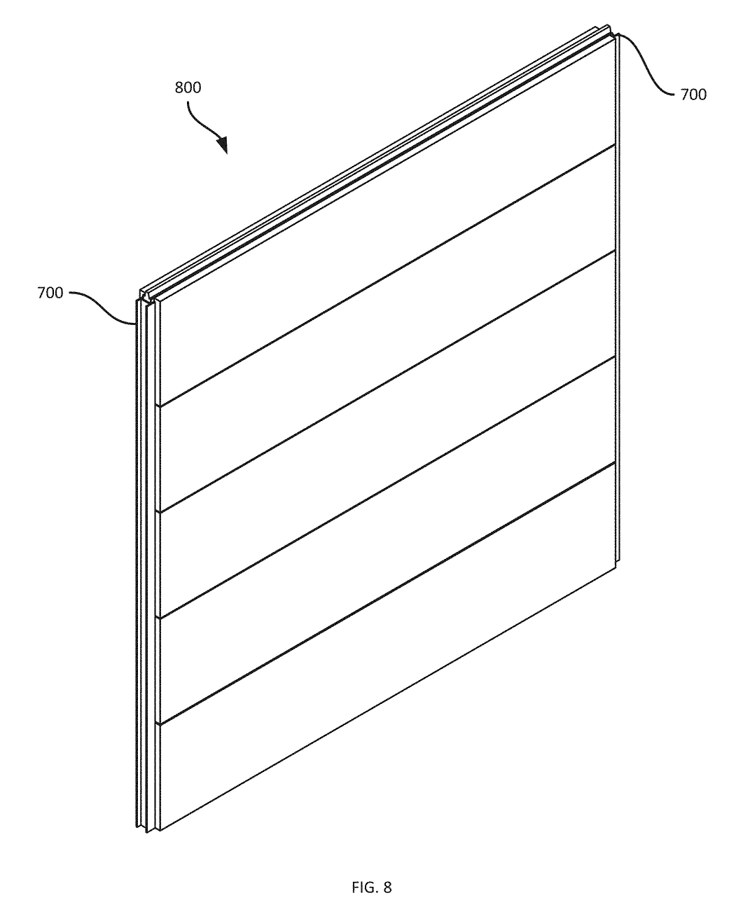

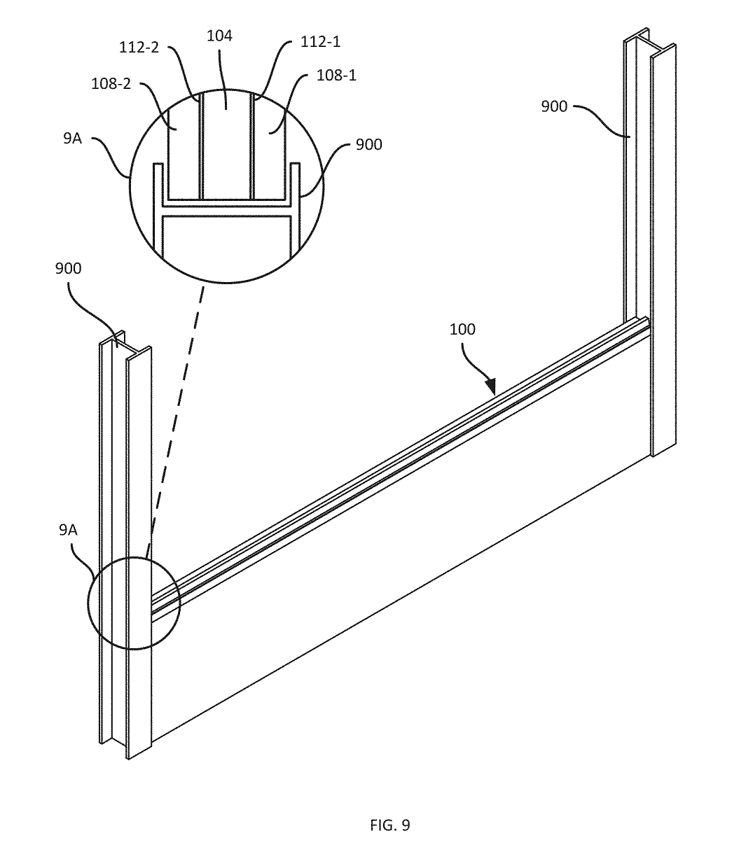

Turning to FIG. 7, the elongated core member 104 of the panel 100a permits the panel 100a to be slotted between supports such as the rails 700. The rails 700 may be embedded in a support surface (e.g. the ground, a roadbed, a foundation or the like), and a plurality of panels 100a may be stacked between each pair of rails 700, as shown in FIG. 7. As shown in the overhead detail view 7A of FIG. 7, the core member 104a and skin members 112a-1 and 112a-2 engage with the rail 700. Thus, as shown in FIG. 8, a sound barrier 800 consisting of the rails 700 and a plurality of panels 100a may be constructed. As will be apparent, additional rails 700 adjacent those shown in FIG. 8 may also be employed to lengthen the barrier 800. Referring to FIG. 9, a sound barrier may also be constructed from panels 100 as shown in FIG. 1 (i.e. without lengthened core members 104a and skin members 112a). In particular, rails 900 are dimensioned such that the entire width of each panel 100 is received within the rail 900, as shown in the overhead detail view 9A.

In the sound barriers of FIGS. 7 and 9, the rails 700 and 900 themselves may have sound attenuation sheets affixed thereto (e.g. via any suitable adhesive) having the same composition as the sound attenuation sheets 108 discussed above. Further, crumb rubber, caulking, or a combination thereof can be employed to seal the panels 100a or 100 with the respective rails 700 or 900, particularly when the rails 700 or 900 are sufficiently large as to permit movement of the panels 100a or 100 within the rails in the absence of such sealing.

Variations to the panels as described above are contemplated. For example, the sound attenuation sheets 108 may have patterns or textures (e.g. patterns or textures mimicking brick, stone, flagstone, and the like) imprinted into the outer surfaces thereof to further dissipate inbound acoustic energy. In some examples, the panels 100 can include lights or other equipment embedded therein. For example, lights can be embedded or otherwise affixed to the core member 104 and/or the skin members 112 and extend through openings in the sound attenuation sheets 108 to illuminate the vicinity of the panel 100. Power and control lines for such lights can travel through channels defined within the core member 104. In further embodiments, a panel 100 or 100a (e.g. the top-most panel shown in FIG. 8) can carry one or more solar panels to collect power for the above-mentioned lights.

As will now be apparent to those skilled in the art, the sound barrier panels described herein may provide certain advantages over sound barrier panels manufactured from materials such as concrete. For example, the panels 100 and 100a described herein may provide sound absorption coefficients of above about 0.6, while having reduced density, and therefore reduced weight at similar dimensions. In some examples, the panels 100 and 100a may provide sound absorption coefficients above about 0.7 (e.g. 0.75). Other advantages may also occur to those skilled in the art.

The scope of the claims should not be limited by the embodiments set forth in the above examples, but should be given the broadest interpretation consistent with the description as a whole.

1. A sound barrier, comprising:
a core member having a perimeter separating opposing first and second side surfaces, the core member formed from a core material including a fiber and a binder;
a first reinforcing skin member having a first inner surface affixed to the first side surface of the core member, and a first outer surface facing away from the core member;
a second reinforcing skin member having a second inner surface affixed to the second side surface of the core member, and a second outer surface facing away from the core member; and
a sound attenuation sheet of crumb rubber applied to the first outer surface of the first reinforcing skin member.

2. The sound barrier of claim 1, wherein the fiber includes one or more of carpet carcass, rice husk, and wood chips.

3. The sound barrier of claim 1, wherein the binder includes a polymer.

4. The sound barrier of claim 3, wherein the polymer includes at one or more of polyurethane and polyvinyl chloride.

5. The sound barrier of claim 1, wherein the first and second reinforcing skin members each comprise a metal sheet.

6. The sound barrier of claim 5, wherein the metal sheet comprises one or more of steel and aluminum.

7. The sound barrier of claim 1, the core member having a first thickness, and the first and second reinforcing members each having a second thickness; wherein the first thickness is greater than the second thickness.

8. The sound barrier of claim 1, wherein the sound attenuation sheet includes a binding agent for binding the crumb rubber.

9. The sound barrier of claim 8, wherein the binding agent includes one or more of polyurethane and latex.

10. The sound barrier of claim 1, further comprising a further sound attenuation sheet of crumb rubber applied to the second outer surface of the second reinforcing skin member.

11. The sound barrier of claim 1, further comprising a first adhesive layer between the core member and each of the first and second reinforcing skin members.

12. The sound barrier of claim 11, further comprising a second adhesive layer between the first reinforcing skin member and the sound attenuating sheet.

13. The sound barrier of claim 12, wherein the first adhesive layer and the second adhesive layer comprise a common adhesive material.

14. The sound barrier of claim 1, wherein the perimeter of the core member includes substantially parallel opposing upper and lower edges and substantially parallel opposing side edges, the upper and lower edges being substantially perpendicular to the side edges.

15. The sound barrier of claim 14, wherein one of the upper and lower edges includes a longitudinal groove; and wherein the other of the upper and lower edges includes a longitudinal tongue complementary to the groove.

16. The sound barrier of claim 15, wherein the core member, the first and second reinforcing skin members and the sound attenuating sheet form a first panel;
the sound barrier further comprising at least one further panel.
